(19) United States
(12) Patent Application Publication
(10) Pub. No.: US 2010/0180623 A1
(43) Pub. Date: Jul. 22, 2010

(54) REFRIGERATOR AND DISPENSER TECHNOLOGY

(75) Inventor: Seung-Hwan OH, Seoul (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/613,676

(22) Filed: Nov. 6, 2009

(30) Foreign Application Priority Data
Nov. 28, 2008 (KR) 10-2008-0120089

(51) Int. Cl. F25C 5/18; F25D 23/02; B67D 7/80

(52) U.S. Cl. 62/344; 62/449; 222/146.6

(57) ABSTRACT

Disclosed is a refrigerator having a dispenser. The refrigerator has a chute that defines an ice flow passage through a door of the refrigerator, and an opening and closing member configured to open and close an outlet of the chute. A cross-sectional area of the outlet of the chute is less than or equal to a cross-sectional area of any other portion of the chute.

### CROSS-REFERENCE TO RELATED APPLICATIONS

Pursuant to 35 U.S.C. §119(a), this application claims the benefit of earlier filing date and right of priority to Korean Application No. 10-2008-0120089, filed on Nov. 28, 2008, the contents of which is incorporated by reference herein in its entirety.

### FIELD

The present disclosure relates to a refrigerator and a dispenser capable of dispensing ice stored in a cooling chamber to an outside of the refrigerator.

### BACKGROUND

A refrigerator is a device capable of maintaining freshness of various foods by supplying cold air generated by a refrigeration cycle to a cooling chamber. A refrigerator includes a main body having a storage chamber for holding foods, and a door coupled with a hinge to one side of the main body for opening or closing the storage chamber. In the main body, a refrigeration cycle is provided to supply cold air to the cooling chamber. The refrigeration cycle may use a vapor-compression refrigeration cycle having a compressor for compressing refrigerant, a condenser for condensing refrigerant, an expansion apparatus for decompressing and expanding refrigerant, and an evaporator for evaporating refrigerant.

A dispenser may be provided on a door of a refrigerator for dispensing water and/or ice without opening the door. The dispenser may include a receiving portion (e.g., a dispenser case) depressed on a front surface of the door in the thickness direction. A chute for communicating an inside of the refrigerator with an outside of the refrigerator may be provided on an upper side of the receiving portion. The chute defines a passage through which ice is moved and an opening and closing member opens and closes an outlet of the chute.

### SUMMARY

In one aspect, a refrigerator having a dispenser includes a refrigerator main body, a cooling compartment defined by the refrigerator main body, and a door configured to open and close at least a portion of the cooling compartment. The refrigerator also includes an ice-making device configured to freeze liquid water into ice and a dispenser positioned at the door and configured to dispense ice made by the ice-making device. The refrigerator further includes a chute that defines an ice flow passage through the door. The chute has an inlet configured to receive ice made by the ice-making device and an outlet configured to release ice guided by the chute to a receiving area of the dispenser. The outlet of the chute has a cross-sectional area that is less than or equal to a cross-sectional area of any other portion of the chute. In addition, the refrigerator includes a member configured to open and close the outlet of the chute.

Implementations may include one or more of the following features. For example, the member may be configured to open and close the outlet by rotating in a thickness direction of the door. The outlet may have a same shape as a cross-section of the chute in a thickness direction of the door. A first direction of a directional vector of the outlet may be the same as a second direction of a directional vector of the member when the member is oriented in a closed position.

In some examples, the chute may have a bending portion between the inlet and the outlet that changes a directional vector of an axis of the cross-section of the chute. In these examples, the chute may include a first communication portion positioned at a first side of the bending portion and a second communication portion positioned at a second side of the bending portion. The first communication portion may be vertically oriented such that a directional vector of an axis of a cross-section of the first communication portion is parallel to an outer surface of the door. A first angle between a plane of the outlet of the chute when the refrigerator is oriented in an ordinary operating orientation and a horizontal plane that is parallel to ground may be the same as a second angle between a plane representing a surface of the second communication portion and a vertical plane that is parallel to an outer surface of the door.

Further, the inlet of the chute may interface with an outlet of an ice storage bin positioned on the door. The outlet of the chute may be positioned in a dispensing cavity defined in the door by the dispenser and the chutes may extend from the outlet of the ice storage bin, through the door, and to the dispensing cavity defined in the door by the dispenser. At least a portion of the chute may guide ice pieces passing through the chute toward a plane representing an external surface of the door. An axis of the chute at the outlet may intersect a plane representing an external surface of the door such that the chute guides ice pieces passing through the outlet toward the plane representing the external surface of the door.

In another aspect, a refrigerator having a dispenser includes a refrigerator main body, a cooling compartment defined by the refrigerator main body, and a door configured to open and close at least a portion of the cooling compartment. The refrigerator also includes an ice-making device configured to freeze liquid water into ice, a dispenser positioned at the door and configured to dispense ice made by the ice-making device, and a chute that defines an ice flow passage through the door. The chute includes a first communication portion configured to receive ice made by the ice-making device at an interior of the door and a second communication portion that is angled with respect to the first communication portion. The second communication portion has an outlet configured to release ice guided by the chute to an exterior of the door. The outlet of the chute has a cross-sectional area that is less than or equal to a cross-sectional area of any other portion of the chute. The refrigerator further includes a member configured to open and close the outlet of the chute.

Implementations may include one or more of the following features. For example, the first communication portion may be vertically oriented such that a directional vector of an axis of a cross-section of the first communication portion is parallel to an outer surface of the door. A first angle between a plane of the outlet of the chute when the refrigerator is oriented in an ordinary operating orientation and a horizontal plane that is parallel to ground may be the same as a second angle between a plane representing a surface of the second communication portion and a vertical plane that is parallel to an outer surface of the door.

The first communication portion may be inclined by an angle of 5 to 25 degrees with respect to a vertical plane that is parallel to an outer surface of the door. The second communication portion may be inclined by an angle of 15 to 35 degrees with respect to the first communication portion. The outlet may have a same shape as that of a cross-section of the chute in a thickness direction of the door.

In yet another aspect, a refrigerator having a dispenser includes a refrigerator main body, a cooling compartment defined by the refrigerator main body, and a door configured to open and close at least a portion of the cooling compartment. The refrigerator also includes an ice-making device configured to freeze liquid water into ice, a dispenser positioned at the door and configured to dispense ice made by the ice-making device, and a chute that defines an ice flow passage through the door. The chute has a bending portion that changes a directional vector of an axis of a cross-section of the chute and an outlet configured to release ice guided by the chute to a receiving area of the dispenser. The outlet of the chute has a cross-sectional area that is less than or equal to a cross-sectional area of any other portion of the chute. The refrigerator further includes a member configured to open and close the outlet of the chute.

Implementations may include one or more of the following features. For example, at least a portion of the chute may guide ice pieces passing through the chute toward a plane representing an external surface of the door. An axis of the chute at the outlet may intersect a plane representing an external surface of the door such that the chute guides ice pieces passing through the outlet toward the plane representing the external surface of the door.

### BRIEF DESCRIPTION OF THE DRAWINGS

FIG. 1 is a view illustrating an outward appearance of a refrigerator having a dispenser;

FIG. 2 is a view illustrating an internal construction of the dispenser in FIG. 1;

FIG. 3 is a view illustrating a cross section of the dispenser in FIG. 1;

FIG. 4 is a view illustrating a chute and an opening and closing member of FIG. 3;

FIG. 5 is a view illustrating a cross section of line I-I in FIG. 4; and

FIG. 6 is a view illustrating a chute of FIG. 3.

### DETAILED DESCRIPTION

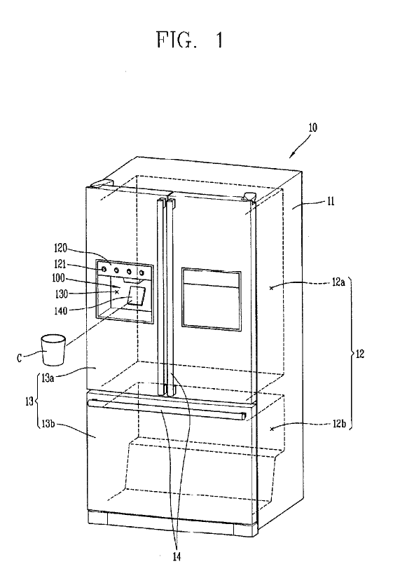

FIG. 1 illustrates an example of a refrigerator 10. The refrigerator 10 includes a refrigerator main body 11 having a cooling chamber 12, and a door 13 for opening and closing the cooling chamber 12. The cooling chamber 12 may include a refrigerating chamber 12a and a freezing chamber 12b. The door 13 includes a refrigerating chamber door 13a for opening and closing the refrigerating chamber 12a and a freezing chamber door 13b for opening and closing the freezing chamber 12b.

Thermal insulation material is filled between an inner surface and an outer to surface of the cooling chamber 12. Based on the thermal insulation material, an inside of the cooling chamber 12 is insulated from an outside of the main body 11.

The cooling chamber 12 has a single access opening for receiving and enabling removal of stored goods. The single access opening is opened or closed by the door 13 that is coupled to the main body 11 by hinges.

Insulation material is inserted in the inside of the door 13. The insulation material reduces heat transfer to the inside of the cooling chamber 12 through the door 13.

A door handle 14 is provided and configured to be grasped by a user. The door handle 14 is coupled to one side of a front surface of the door 13, thereby allowing a user to open and close the door 13 more easily.

In addition, a refrigeration cycle (not shown) is provided to generate cold air for cooling the cooling chamber 12 at one side of the main body 11. The refrigeration cycle may use a vapor-compression refrigeration cycle having a compressor for compressing refrigerant, a condenser for condensing refrigerant, an expansion apparatus for decompressing and expanding refrigerant, and an evaporator for evaporating refrigerant.

The cold air generated by the refrigeration cycle is supplied to the cooling chamber 12 through a cold air supply duct (not shown) that is defined within the main body 11. The temperature and/or amount of cold air supplied to the cooling chamber 12 may be controlled to maintain the cooling chamber 12 at a refrigerating temperature above freezing or at a freezing temperature below freezing. Different compartments in the cooling chamber 12 may be maintained at different temperatures. For instance, the refrigerating chamber 12a may be maintained at a refrigerating temperature and the freezing chamber 12b may be maintained at a freezing to temperature.

A ventilation device (not shown) may be provided to supply cold air to the cold air supply duct. The ventilation device (e.g., a fan) may continuously supply cold air to the cold air supply duct.

The refrigerating chamber 12a and the freezing chamber 12b may have various shapes and configurations. A user may select the shape or configuration according to the user's preference, and the kind or amount of stored goods. Although FIG. 1 illustrates a case where a refrigerating chamber 12a is arranged in the upper side, and a freezing chamber 12b is arranged in the lower side, a freezing chamber 12b may be arranged in the upper side and a refrigerating chamber 12a in the lower side. Further, the refrigerating chamber 12a and freezing chamber 12b may be arranged side by side in the left and right sides.

The refrigerator 10 includes a dispenser 100 for dispensing pieces of ice that have been made in the cooling chamber 12 to an outside of the refrigerator without opening the door 13. The dispenser 100 dispenses ice pieces from a compartment inside of the refrigerator 10 through the door 13.

The dispenser 100 is provided with a receiving portion 130 that is depressed a predetermined area in a thickness direction from a front surface of the door 13, and a press button 140 provided within the receiving portion 130 for controlling (e.g., starting and stopping) a dispensing operation of the pieces of ice, water, or the like. In an upper side of the front surface of the receiving portion 130, a closed portion 120 may be provided to close a mechanical device that performs an operation of the dispenser 100 and is located at a rear side of the receiving portion 130. The closed portion 120 may shield the mechanical device from view such that the mechanical device is difficult (or impossible) to view from an outside of the refrigerator 10.

The closed portion 120 includes a plate-shaped member having a plastic material, and a control button portion 121 that controls a state of the pieces of ice or the like that are dispensed through the dispenser 100 and an operation state of the refrigerator 10. When the press button 140 is pressed using a container (C) by a user, the pieces of ice are dispensed by an operation of the mechanical device in the dispenser 100.

Although FIG. 1 shows the dispenser 100 being provided in a refrigerating chamber door 13a, other locations are possible. For example, the dispenser 100 may be provided in a freezing chamber door 13b or another wall that defines the refrigerator 10.

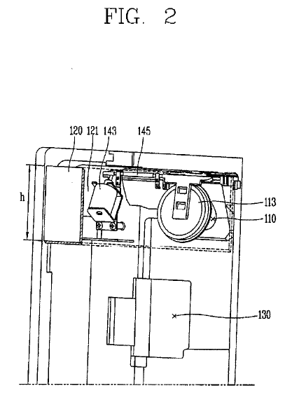

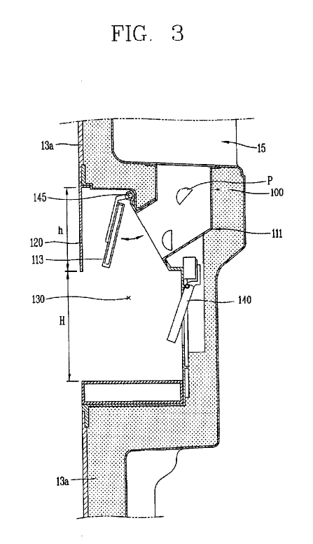

FIGS. 2 and 3 illustrate an example of a dispenser. As shown in FIG. 3, an ice-making device 15 is provided within the cooling chamber 12 and configured to make pieces of ice or the like that are dispensed through the dispenser 100. The ice-making device 15 communicates with the dispenser 100. For example, a chute 110 defines a passage from the ice-making device 15 to the dispenser 100, and guides the pieces of ice or the like that have been made by the ice-making device 15.

The ice-making device 15 may be provided in an inner side of the cooling chamber 12 or a rear surface of the door 13, that is, a surface facing to the cooling chamber 12. The ice-making device 15 may include an ice maker configured to freeze liquid water into ice and an ice storage area or bin that is configured to store ice made by the ice maker. The chute 110 may define a passage from the ice storage area or bin of the ice-making device 15 to the dispenser 100. Any type of ice-making device may be used as the ice-making device 15.

The chute 110 is opened and closed selectively by a user or the like to control dispensing of ice pieces. An opening and closing member 113 opens and closes an outlet of the chute 110 based on user input. The opening and closing member 113 has a shape that corresponds to the outlet of the chute 110.

The opening and closing member 113 is coupled to a rotation shaft 145, and the rotation shaft 145 is rotated by a solenoid 143 located to a side of the opening and closing member 113 with reference to FIG. 2. As such, the opening and closing member 113 is opened and closed by rotation of the rotation shaft 145. In this regard, the opening and closing member 113 is rotated in a thickness direction of the door 13a to open and close the chute 110.

The opening and closing member 113, the solenoid 143, and the rotation shaft 145 are visibly hidden from an outside of the refrigerator by the closed portion 120. The height (h) of the closed portion 120 is selected by considering a rotation radius of the opening and closing member 113 and choosing a height that hides the opening and closing member 113 throughout its path of rotation.

A passage is defined in the chute 110 that communicates a bottom surface of the ice-making device 15 with a surface opened and closed by the opening and closing member 113. Ice pieces move from the ice-making device 15 along the passage to an outlet of the chute 110 that is opened and closed by the opening and closing member 113.

A cross-sectional area of the chute 110 is larger than a minimum area needed to move the pieces of ice or the like. A cross-sectional area at the outlet side of the chute 110 (e.g., a surface opened and closed by the opening and closing member 113) has a minimum area of any portion of the chute 110. For instance, the chute 110 may narrow toward an outlet of the chute 110.

Based on this configuration, a size of the opening and closing member 113 may be reduced. In addition, an area being opened and closed by the opening and to closing member 113 is reduced, thereby enhancing the sealing performance of the chute 110 and effectively preventing the leakage of cold air.

Moreover, a rotation radius of the opening and closing member 113 is reduced as much as the size of the opening and closing member 113 is reduced. Therefore, the height (h) of the closed portion 120 is reduced, and accordingly, the height (H) of the receiving portion 130 capable of receiving a container (C) or the like is increased without having to increase an overall height of the dispenser.

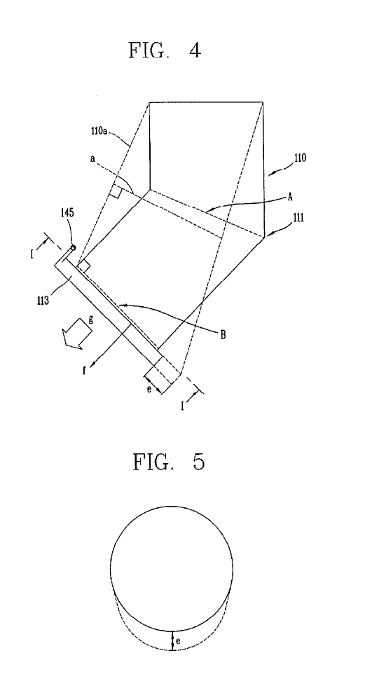

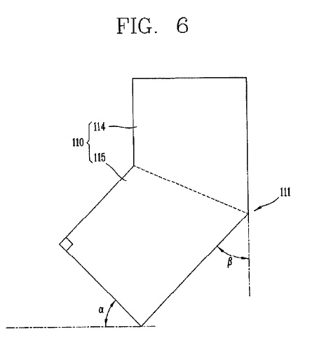

FIGS. 4 and 5 illustrate an example structure of a chute that reduces a size of an opening and closing member. FIG. 4 shows an example chute and an example opening and closing member from FIG. 3, and FIG. 5 shows a cross section of line I-I in FIG. 4. FIG. 6 illustrates an example chute from FIG. 3.

First, referring to FIGS. 4 and 5, the chute 110 has a bending portion 111 that changes a directional vector of a cross-section of the chute 110 in a thickness direction. The directional vector is a vertical direction against the cross section in the thickness direction of the chute 110. An outlet-side cross section of the chute 110 may be provided with a minimum area for passing the pieces of ice.

In some dispensers, a chute 110 is provided by inclining downward to move the pieces of ice stored in the inside of the door 13a to a dispenser 100 arranged in an outer surface of the door 13a. An example of these types of dispensers is illustrated as a dotted line in FIG. 4.

As seen in the dotted line of FIG. 4, a minimum area of a chute 110a is located at a middle position in the length direction of the chute 110a, not at an outlet-side cross section of the chute 110a. The outlet-side cross section has a larger cross-sectional area than other portions of the chute 110a and the cross-section of the chute 110a increases closer to the outlet.

In these examples, the outlet-side cross section of the chute 110a has an elliptical shape as shown in a dotted line in FIG. 5. A rotation radius of an opening and closing member 113 becomes more lengthy, as much as a predetermined length (e) more than that of the chute 110 shown in FIG. 4.

As shown in FIG. 4, a bending portion 111 for changing a directional vector (f) of the cross-section of the chute 110 in the thickness direction, and therefore, a cross section opened and closed by an opening and closing member 113 becomes smaller in a vertical direction while, at the same time, a directional vector (g) in a state that the opening and closing member 113 is closed remains the same.

A cross section of the outlet side (outlet port) of the chute 110 opened and closed by the opening and closing member 113 may be the same as a cross section of the chute 110 in the thickness direction. In other words, in a state that the opening and closing member 113 is closed, a wall of the chute 110 and the opening and closing member 113 are located vertically to each other.

Based on this configuration, a cross-sectional area of the outlet side of the chute 110 is reduced, with a minimum cross-section of the chute 110 being located at the outlet. A size of the opening and closing member 113 for opening and closing the outlet also is reduced.

A directional vector (f) of the outlet-side cross section of the chute 110 opened and closed by the opening and closing member 113 (i.e., a directional vector (f) of the outlet port of the chute 110) is similar to a directional vector (g) of the opening and closing member 113 in a state that the opening and closing member 113 is closed. Accordingly, an outlet-side cross section of the chute 110, that is, a cross sectional area that is opened and closed by an opening and closing member 113, is reduced. In some implementations, a directional vector of the cross section of an end of the chute 110 opened and closed by the opening and closing member 113 is different from a directional vector of the opening and closing member 113 in a state that the opening and closing member 113 is closed, thereby having an advantage of preventing the dispersion of the pieces of ice or the like.

Referring to FIG. 6, the chute 110 includes a first communication portion 114 for communicating vertically downward from the ice-making device 15, and a second communication portion 115 that is bent from the first communication portion 114 to communicate with the receiving portion 130.

An exit-side cross section of the second communication portion 115, that is, an outlet plane of the 110, is a vertical cross section of the chute 110 in the thickness direction, and its directional vector (f) is similar to a directional vector (g) in a state that the opening and closing member 113 is closed.

Moreover, an angle (α) between a cross section of an outlet-side end (outlet plane) of the chute 110 and a horizontal plane may be formed similarly to an angle (β) that the chute 110 is bent against a vertical plane. The first communication portion 114 may be arranged vertically. In addition, the first communication portion 114 may be arranged by inclining downward to the front in the range of 5 to 25 degrees against a vertical plane. Furthermore, the second communication portion 115 may be arranged by inclining in the range of 15 to 35 degrees against the first communication portion 114.

As described above, in some implementations, a cross-sectional area of the chute opened and closed by the opening and closing member has a minimum area for passing the pieces of ice as compared to other portions of the chute. This may have an advantage of reducing the size of the opening and closing member. In this regard, a rotation radius of the opening and closing member also may be reduced, thereby enlarging a size of the receiving portion without increasing a size of the dispenser. Accordingly, containers having various (e.g., larger) sizes can be used when dispensing water or ice, thereby promoting a user's convenience.

Furthermore, an area opened and closed by the opening and closing member can be reduced, and therefore, a sealing performance of the chute is enhanced, thereby effectively preventing the leakage of cold air.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A refrigerator having a dispenser, comprising:
a refrigerator main body;
a cooling compartment defined by the refrigerator main body;
a door configured to open and close at least a portion of the cooling compartment;
an ice-making device configured to freeze liquid water into ice;
a dispenser positioned at the door and configured to dispense ice made by to the ice-making device;
a chute that defines an ice flow passage through the door, the chute having an inlet configured to receive ice made by the ice-making device and an outlet configured to release ice guided by the chute to a receiving area of the dispenser, the outlet of the chute having a cross-sectional area that is less than or equal to a cross-sectional area of any other portion of the chute; and
a member configured to open and close the outlet of the chute.

2. The refrigerator having a dispenser of claim 1, wherein the member is configured to open and close the outlet by rotating in a thickness direction of the door.

3. The refrigerator having a dispenser of claim 1, wherein the outlet has a same shape as a cross-section of the chute in a thickness direction of the door.

4. The refrigerator having a dispenser of claim 1, wherein a first direction of a directional vector of the outlet is the same as a second direction of a directional vector of the member when the member is oriented in a closed position.

5. The refrigerator having a dispenser of claim 1, wherein the chute has a bending portion between the inlet and the outlet that changes a directional vector of an axis of the cross-section of the chute.

6. The refrigerator having a dispenser of claim 5, wherein the chute includes a first communication portion positioned at a first side of the bending portion, and a second communication portion positioned at a second side of the bending portion.

7. The refrigerator having a dispenser of claim 6, wherein the first communication portion is vertically oriented such that a directional vector of an axis of a cross-section of the first communication portion is parallel to an outer surface of the door.

8. The refrigerator having a dispenser of claim 6, wherein a first angle between a plane of the outlet of the chute when the refrigerator is oriented in an ordinary operating orientation and a horizontal plane that is parallel to ground is the same as a second angle between a plane representing a surface of the second communication portion and a vertical plane that is parallel to an outer surface of the door.

9. The refrigerator having a dispenser of claim 1, wherein the inlet of the chute interfaces with an outlet of an ice storage bin positioned on the door, the outlet of the chute is positioned in a dispensing cavity defined in the door by the dispenser, and the chutes extends from the outlet of the ice storage bin, through the door, and to the dispensing cavity defined in the door by the dispenser.

10. The refrigerator having a dispenser of claim 1, wherein at least a portion of the chute guides ice pieces passing through the chute toward a plane representing an external surface of the door.

11. The refrigerator having a dispenser of claim 1, wherein an axis of the chute at the outlet intersects a plane representing an external surface of the door such that the chute guides ice pieces passing through the outlet toward the plane representing the external surface of the door.

12. A refrigerator having a dispenser, comprising:
a refrigerator main body;
a cooling compartment defined by the refrigerator main body;
a door configured to open and close at least a portion of the cooling compartment;
an ice-making device configured to freeze liquid water into ice;
a dispenser positioned at the door and configured to dispense ice made by the ice-making device;
a chute that defines an ice flow passage through the door, the chute including:
a first communication portion configured to receive ice made by the ice-making device at an interior of the door, and
a second communication portion that is angled with respect to the first communication portion, the second communication portion having an outlet configured to release ice guided by the chute to an exterior of the door, the outlet of the chute having a cross-sectional area that is less than or equal to a cross-sectional area of any other portion of the chute; and a member configured to open and close the outlet of the chute.

13. The refrigerator having a dispenser of claim 12, wherein the first communication portion is vertically oriented such that a directional vector of an axis of to a cross-section of the first communication portion is parallel to an outer surface of the door.

14. The refrigerator having a dispenser of claim 13, wherein a first angle between a plane of the outlet of the chute when the refrigerator is oriented in an ordinary operating orientation and a horizontal plane that is parallel to ground is the same as a second angle between a plane representing a surface of the second communication portion and a vertical plane that is parallel to an outer surface of the door.

15. The refrigerator having a dispenser of claim 12, wherein the first communication portion is inclined by an angle of 5 to 25 degrees with respect to a vertical plane that is parallel to an outer surface of the door.

16. The refrigerator having a dispenser of claim 12, wherein the second communication portion is inclined by an angle of 15 to 35 degrees with respect to the first communication portion.

17. The refrigerator having a dispenser of claim 12, wherein the outlet has a same shape as that of a cross-section of the chute in a thickness direction of the door.

18. A refrigerator having a dispenser, comprising:
a refrigerator main body;
a cooling compartment defined by the refrigerator main body;
a door configured to open and close at least a portion of the cooling compartment;
an ice-making device configured to freeze liquid water into ice;
a dispenser positioned at the door and configured to dispense ice made by the ice-making device;
a chute that defines an ice flow passage through the door, the chute having a bending portion that changes a directional vector of an axis of a cross-section of the chute and an outlet configured to release ice guided by the chute to a receiving area of the dispenser, the outlet of the chute having a cross-sectional area that is less than or equal to a cross-sectional area of any other portion of the chute; and
a member configured to open and close the outlet of the chute.

19. The refrigerator having a dispenser of claim 18, wherein at least a portion of the chute guides ice pieces passing through the chute toward a plane representing an external surface of the door.

20. The refrigerator having a dispenser of claim 18, wherein an axis of the chute at the outlet intersects a plane representing an external surface of the door such that the chute guides ice pieces passing through the outlet toward the plane representing the external surface of the door.
